(19) United States
(12) Patent Application Publication
(10) Pub. No.: US 2018/0281728 A1
(43) Pub. Date: Oct. 4, 2018

(54) DEPLOYABLE AIRBAG POSITIONER AND METHOD

(71) Applicant: NextEV USA, Inc., San Jose, CA (US)

(72) Inventors: Heng Zhang, San Jose, CA (US); Jeffrey D. Rupp, San Jose, CA (US); Christopher Eckert, San Jose, CA (US); Yih-Charng Deng, San Jose, CA (US)

(73) Assignee: NextEV USA, Inc., San Jose, CA (US)

(21) Appl. No.: 15/473,145

(22) Filed: Mar. 29, 2017

(51) Int. Cl. B60R 21/203; B60R 21/18; B60R 21/261; B60R 21/0136

(52) U.S. Cl. CPC B60R 21/203; B60R 21/18; B60R 2021/161; B60R 21/0136; B60R 21/261

(57) ABSTRACT

A system and method of inflating an airbag are disclosed. The system and method include detecting application of a force at at least one of a plurality of sensors, initiating an inflation system to cause inflation of the airbag and an airbag positioner responsive to the detecting, inflating the airbag positioner based on the initiating, inflating the airbag, and breaching a compartment initially housing at least one of the airbag and the airbag positioner. The system and method include inflating the airbag positioner to reposition an out-of-position occupant reducing the constraints on the design of the airbag and improving protection for the in-position occupant.

### FIELD OF INVENTION

The present invention is related to airbag deployment and particularly to the inclusion of a steering wheel deployable airbag positioner.

### BACKGROUND

Airbag design is required to satisfy certain criteria for occupants including out-of-position (OOP) occupants. Airbag suppliers have relied on tuning the inflator and airbag design to satisfy the in-position (IP) and OOP occupant requirements simultaneously. Generally, satisfying the requirements simultaneously leads to a compromise for the IP occupants. Therefore, a need exists to disconnect the design of IP and OOP occupants so that a compromise of the IP occupant is not needed.

### SUMMARY

A system and method of inflating an airbag are disclosed. The system and method include detecting application of a force at at least one of a plurality of sensors, initiating an inflation system to cause inflation of the airbag and an airbag positioner responsive to the detecting, inflating the airbag positioner based on the initiating, inflating the airbag, and breaching a compartment initially housing at least one of the airbag and the airbag positioner. The system and method include inflating the airbag positioner to reposition an out-of-position occupant reducing the constraints on the design of the airbag and improving protection for the in-position occupant. The airbag positioner may be an airbag. The airbag positioner is inflated or sized to produce a force to re-position an out-of-position occupant.

A passive restraint system is also disclosed. The passive restraint system includes an airbag that is capable of deploying upon impact to restrain a body of at least one occupant, and at least one airbag positioner operating in conjunction with the airbag, the at least one airbag positioner capable of repositioning the occupant if the original position of the occupant is out-of-position. The repositioning the out-of-position occupant reduces the constraints on the design of the airbag and improves protection for the in-position occupant. The airbag positioner may be an airbag. The airbag positioner is inflated or sized to produce an appropriate force to re-position an out-of-position occupant.

An automobile including a passive restraint system is also disclosed. The automobile includes an airbag that is capable of deploying upon impact to restrain a body of at least one occupant, and at least one airbag positioner operating in conjunction with the airbag, the at least one airbag positioner capable of repositioning the occupant if the original position of the occupant is out-of-position. The repositioning the out-of-position occupant reduces the constraints on the design of the airbag and improves protection for the in-position occupant. The airbag positioner may be an airbag. The airbag positioner is inflated or sized to produce an appropriate force to re-position an out-of-position occupant.

### BRIEF DESCRIPTION OF THE DRAWINGS

A more detailed understanding can be had from the following description, given by way of example in conjunction with the accompanying drawings wherein:

FIG. 1A illustrates an airbag and associated inflation device depicted in an uninflated state from an isometric view;

FIG. 1B illustrates an airbag and associated inflation device depicted in an uninflated state from a front view;

FIG. 2A illustrates an airbag and associated inflation device depicted in an inflated state from an isometric view;

FIG. 2B illustrates an airbag and associated inflation device depicted in an inflated state from a front view;

FIG. 3 illustrates a method of inflating an airbag and airbag positioner;

FIG. 4 illustrates a diffuser plate that may be used to control the flow of gas into the airbag and airbag positioner;

FIG. 5A illustrates an example airbag positioner from a front view;

FIG. 5B illustrates an example airbag positioner from a side view; and

FIG. 6 illustrates a dashboard of a vehicle to provide areas where the present airbag positioner may be implemented.

### DETAILED DESCRIPTION

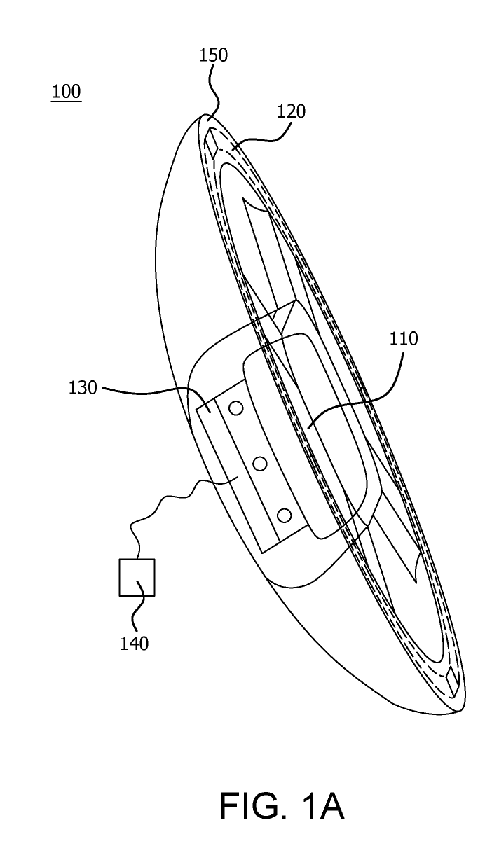

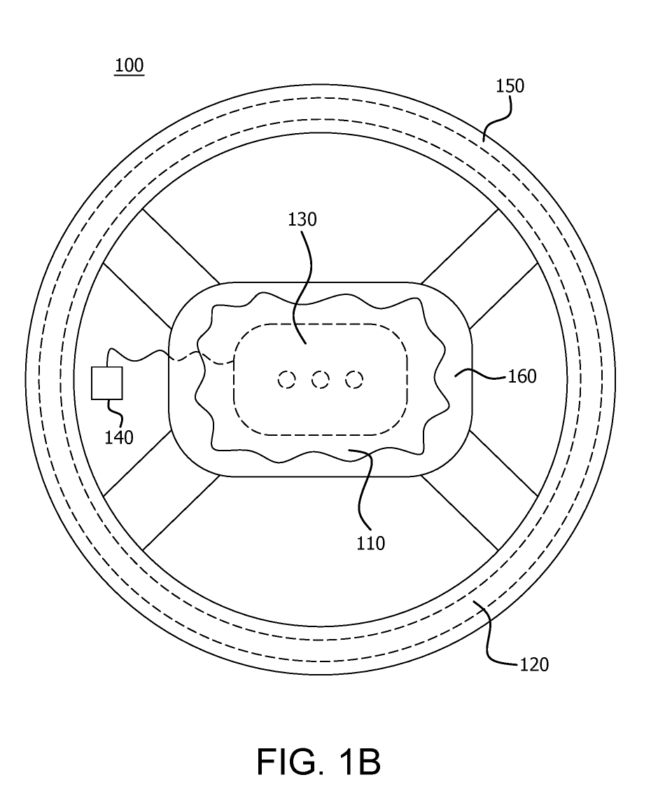

FIGS. 1A and 1B collectively illustrate an airbag and associated inflation device 100 depicted in an uninflated state. Airbag and associated inflation device 100 includes an airbag 110, an airbag positioner 120, an inflation system 130, and a sensor or plurality of sensors 140. As shown in FIGS. 1A and 1B, airbag and associated inflation system 100 is depicted within a steering wheel assembly including a steering wheel 150 and a steering wheel compartment 160. While shown within the steering wheel, airbag and associated inflation device 100 may be located in a myriad of different locations as would understood to those possessing an ordinary skill in the pertinent arts, and as will be set forth herein below.

In an implementation, airbag 110 is made of thin, nylon fabric and folded into steering wheel compartment 160 or other compartment in the vehicle. As is known to those possessing an ordinary skill in the art, airbag 110 may be part of a passive vehicle restraint system within a vehicle; the airbag 110 being designed to rapidly inflate on impact to restrain the body of an occupant or occupants, often above torso level, to prevent direct contact with the vehicle structure.

Airbag 110 may have associated therewith an airbag positioner 120 which may also be referred to as an airbag cushion. Airbag positioner 120 may also be made of thin, nylon fabric. Airbag positioner 120 may be included within airbag 110, may be discrete from airbag 110, or may be adjacent to airbag 110 (as shown), such as in the steering wheel rim, for example. Airbag 110 and airbag positioner 120 may be inflated by inflation system 130. As shown, a single inflation system 130 may be used for the inflation of both airbag 110 and airbag positioner 120, although multiple inflation systems 130 may be used for inflation of airbag 110 and/or airbag positioner 120. Each of airbag 110 and airbag positioner 120 may have discrete inflation systems 130. While a single airbag positioner 120 and/or airbag 110 is discussed in the examples below, the present invention encompasses the use of multiple airbag positioners 120 and/or multiple airbags 110.

Airbag positioner 120 may be sized or may be fed by inflation system 130 to generate a small amount of force to push the occupant's head, neck or chest away from the deploying airbag 110. This push may move the out-of-position (OOP) occupant to lessen the potential realm of positions the OOP occupant may occupy. The push of the occupant may occur either before or during the deployment of airbag 110. The push may include constraining the OOP occupant to a smaller OOP location, in order to provide less constraint on the airbag 110 design dictated by the OOP occupant allow more design freedom to offer better protection for the in-position (IP) occupant.

The size of airbag positioner 120 may be used to cause a force to push or move the OOP occupant. The inflation rate or other configurations may be used to alternatively or additionally cause the push force.

Airbag positioner 110 may include a deployable positioner or other movable apparatus that is deployed to interact with the occupant for purposes of repositioning the occupant prior to occupant's interaction with the airbag 110. That is, airbag positioner 110 may be any mechanical device and may not be a type of airbag at all, even though the present examples show airbag positioner as an airbag.

Inflation system 130 may include an inflator mechanism, such as a chemical reaction to produce a large pulse of gas. This gas inflates airbag 110 and airbag positioner 120, thereby causing airbag 110 and airbag positioner 120 to burst out of steering wheel compartment 160 or other compartment as airbag 110 and airbag positioner 120 expand. The breaching of steering wheel compartment 160 may be caused by the inflation of airbag positioner 120 without any inflation of airbag 110, by the inflation of airbag 110 without any inflation of the airbag positioner 120, or may be caused by a combination of the inflation of airbag positioner 120 and airbag 110 with any combination between the airbag positioner 120 and airbag 110. Airbag 110 and airbag positioner 120 are deflated as appropriate during the energy absorption phase of interaction with the vehicle occupant.

Inflation system 130 may be controlled or initiated by a single or series of signals from a sensor or plurality of sensors 140. Sensors 140 may detect an impact or deceleration of the vehicle and provide a signal to inflation system 130 to initiate inflation of airbag 110 and airbag positioner 120. Sensors 140 send an electric signal to inflation system 130 to initiate filing of airbag 110 and airbag positioner 120. Sensors 140 may be located throughout the vehicle, generally at the periphery of the vehicle, such as in the doors, in the front and back of the vehicle.

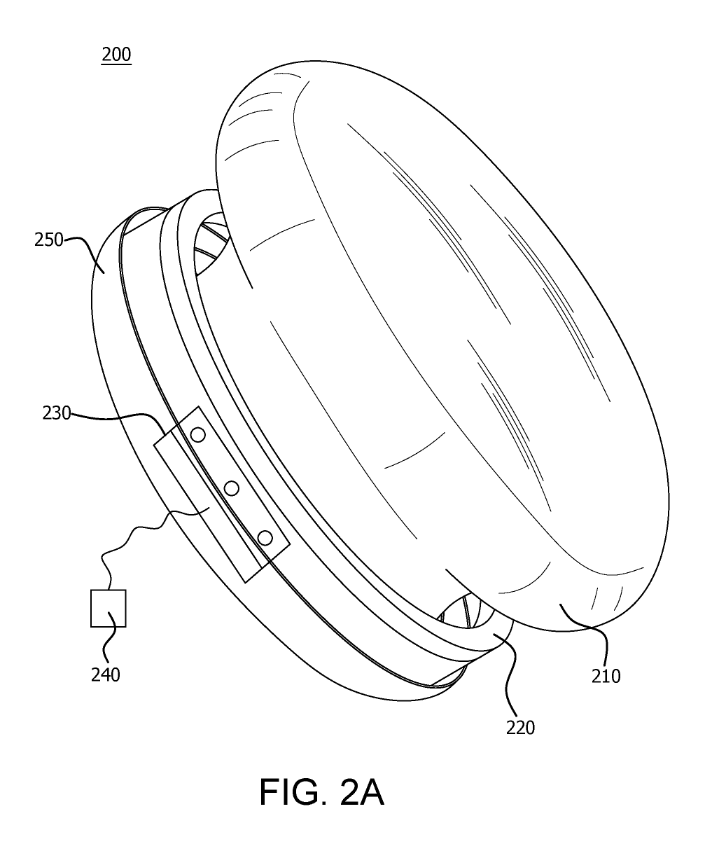

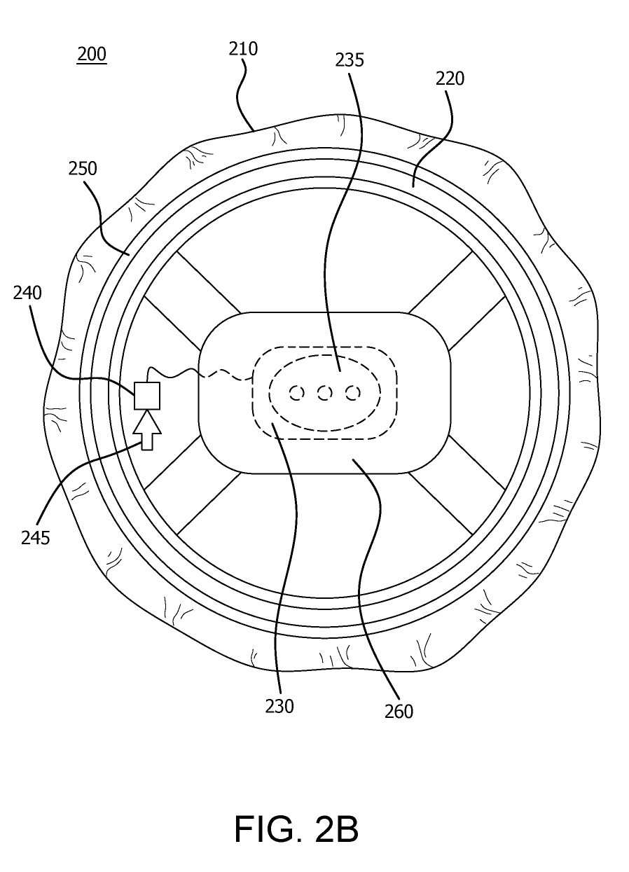

FIGS. 2A and 2B collectively illustrate an airbag and associated inflation device 200 depicted in an inflated state. While FIGS. 2A and 2B represent of an airbag and inflation device 200, FIGS. 2A and 2B collectively provide illustration of the parts of the present invention and is not intended to provide an actual depiction of the shape or configuration of an actual inflated airbag.

Airbag and associated inflation device 200 is a depiction of the inflated state of the airbag and associated inflation device 100 of FIG. 1. Airbag and associated inflation device 200 includes an airbag 210, an airbag positioner 220, an inflation system 230, and a sensor or plurality of sensors 240. As shown in FIGS. 2A and 2B, airbag and associated inflation system 200 is depicted within a steering wheel assembly including a steering wheel 250 and a steering wheel compartment 260 for consistency with the example depicted in FIG. 1.

Upon application of a force 245, or otherwise initiating sensor 240, a signal is generated by the sensor 240 and sent to inflation system 230 initiating inflation. This results in airbag 210 and airbag positioner 220 inflating and breaching compartment 260. Airbag 210 and airbag positioner 220 may be within a common compartment or may be separate compartments.

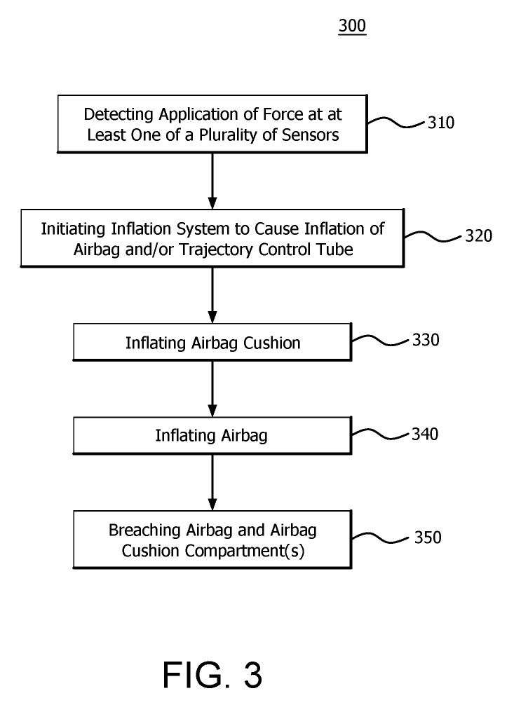

FIG. 3 illustrates a method 300 of inflating an airbag and airbag positioner. Method 300 includes detecting application of a force at at least one of a plurality of sensors at step 310. At step 320, method 300 includes initiating the inflation system to cause inflation of airbag and airbag positioner. At step 330, method 300 includes inflating the airbag positioner. Inflating the airbag positioner generates a small amount of force to push the occupant's head, neck or chest away from the deploying airbag at step 330. Method 300 includes inflating the airbag at step 330 and breaching the airbag and/or airbag positioner compartment at step 350.

As set forth hereinbefore, inflating the airbag positioner generates a small amount of force to reposition the occupant away from the deploying airbag. This force generation may occur before the airbag inflates, as the airbag begins to inflate, and/or as the airbag inflates.

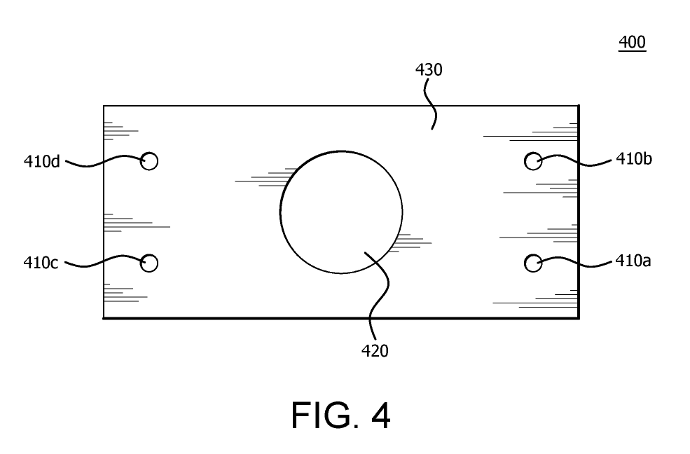

By way of example, in an implementation illustrated in FIG. 4 a diffuser plate 400 may be used to control the flow of gas into the airbag and airbag positioner. The diffuser plate 400 may include a main body 430 that mounts the diffuser plate 400 to the airbag (not shown) and the airbag positioner (not shown). A series of holes 410a, b, c, d may be provided, thereby allowing the gas contained on one side of the diffuser plate 400 to expand and inflate the airbag positioner. A second series of holes 420 (shown as only a single larger hole in the depiction) may be used to direct the remaining expanding gas into the airbag. The ratio of the area of the airbag positioner holes 410a, b, c, d and the airbag holes 420 may be used to control the respective rates of inflation of the airbag and airbag positioner to allow the airbag positioner to inflate more quickly and/or with less velocity than the airbag, to provide the guiding forces to position the occupant as desired or otherwise re-position the occupant, as discussed, before and during inflation of the airbag. Other mechanisms for controlling the inflation of the airbag positioner and airbag may be used while the implementation of FIG. 4 illustrates only one way of performing the inflation by example only. These other mechanisms include having separate inflators for each, for example.

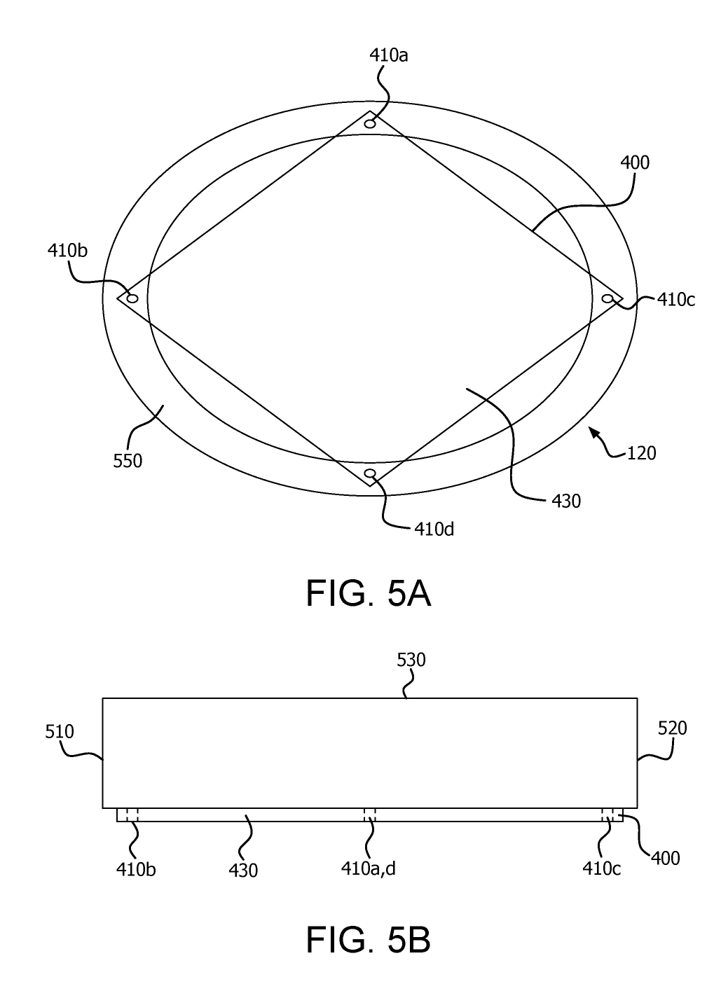

FIGS. 5A and 5B collectively illustrate an exemplary airbag positioner 120. Airbag positioner 120 may be condensed into a non-filled tube depicted as non-filled tube 550. The base of airbag positioner 120 may be coupled to the main body 430 of diffuser plate 400 and may be filled upon activation of the gas via an opening, hole or series of holes 410a,b,c,d.

Upon application of gas, non-filled tube 550 becomes filled with gas via holes 410a,b,c,d and expands from the non-filled state to take the shape defined by the materials and geometry of the airbag positioner 120. This may include a first side 510 of airbag positioner 120 and a second side 520 of airbag positioner 120 illustrated in the two-dimensional depiction of FIG. 5B. As it inflates with gas, air positioner 120 generates the pushing force via the distal end 530 of airbag positioner 120. The distal end 530 ultimately defines a point or plane in space distal to the diffuser plate 400 base on the specific geometry of the design of airbag positioner 120. The movement from the non-filled position to the skilled state of distal end 530 creates the pushing force of air positioner 120.

Alternatively, or additionally, there also may be a physical attachment between the airbag positioner 120 and the airbag 110 which may provide advantages in the inflation of airbag 110 once airbag positioner 120 creates and utilizes the pushing force and subsequently becoming unnecessary.

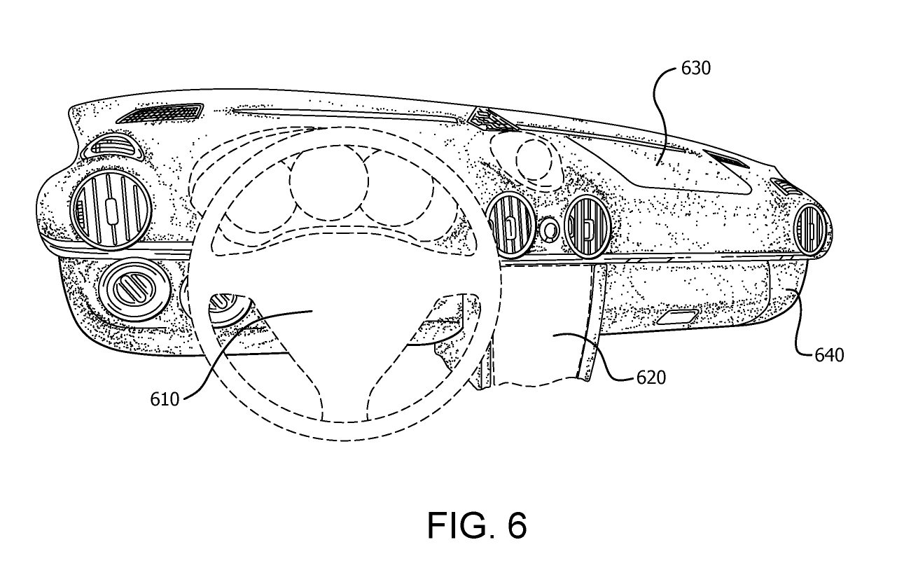

FIG. 6 illustrates a dashboard of a vehicle to provide areas where the present airbag positioner may be implemented. By way of non-limiting example only, the present airbag positioner and airbag may be deployed in the steering wheel 610, above center on the dashboard 620, in the center console 620, and below center on the dashboard 640. The airbag may also be located within the ceiling of the vehicle (not shown), the door of the vehicle (not shown), the seat where the airbag is deployed to protect the occupant seated in the seat (not shown) and/or the seat where the airbag is deployed to protect the occupant seated behind the seat (not shown). The airbag positioner may also be located within the ceiling of the vehicle (not shown), the door of the vehicle (not shown), the seat where the airbag positioner is deployed to protect the occupant seated in the seat (not shown) and/or the seat where the airbag positioner is deployed to protect the occupant seated behind the seat (not shown). The airbag positioner described above may be utilized to generate a small amount of force to push the occupant's head, neck or chest away from the deploying airbag.

Other locations for the airbag positioner may include part of the shoulder belt, the center of the steering wheel, steering wheel spoke or spokes, forward of steering wheel including on the steering column, attachment to the steering column, the knee bolster, or other instrument panels location, and may be deployed through a gap in the steering wheel rim and the center.

Having thus described the presently preferred embodiments in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiments and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A method of inflating an airbag, the method comprising:
detecting application of a force at at least one of a plurality of sensors;
initiating an inflation system to cause inflation of the airbag and an airbag positioner responsive to the detecting;
inflating the airbag positioner based on the initiating, wherein inflating the airbag positioner repositions an out-of-position occupant;
inflating the airbag; and
breaching a compartment initially housing at least one of the airbag and the airbag positioner.

2. The method of claim 1 wherein the repositioning the out-of-position occupant reduces the constraints on the design of the airbag.

3. The method of claim 2 wherein reducing the constraints improves protection for the in-position occupant.

4. The method of claim 2 wherein the airbag positioner is located on the shoulder belt.

5. The method of claim 1 wherein the airbag positioner is located within the steering wheel.

6. The method of claim 1 wherein the airbag positioner is an airbag.

7. The method of claim 6 wherein the airbag positioner is inflated or sized to produce of force to re-position an out-of-position occupant.

8. A passive restraint system, the system comprising:
an airbag that is capable of deploying upon impact to restrain a body of at least one occupant; and
at least one airbag positioner operating in conjunction with the airbag, the at least one airbag positioner capable of repositioning the occupant if the original position of the occupant is out-of-position.

9. The system of claim 8 wherein the repositioning the out-of-position occupant reduces the constraints on the design of the airbag.

10. The system of claim 9 wherein reducing the constraints improves protection for the in-position occupant.

11. The system of claim 8 wherein the airbag positioner is located within the steering wheel.

12. The system of claim 8 wherein the airbag positioner is located on the shoulder belt.

13. The system of claim 8 wherein the airbag positioner is an airbag.

14. The system of claim 13 wherein the airbag positioner is inflated or sized to produce of force to re-position an out-of-position occupant.

15. An automobile including a passive restraint system, the automobile comprising:
an airbag that is capable of deploying upon impact to restrain a body of at least one occupant; and
at least one airbag positioner operating in conjunction with the airbag, the at least one airbag positioner capable of repositioning the occupant if the original position of the occupant is out-of-position.

16. The automobile of claim 15 wherein the repositioning the out-of-position occupant reduces the constraints on the design of the airbag.

17. The automobile of claim 16 wherein reducing the constraints improves protection for the in-position occupant.

18. The automobile of claim 15 wherein the airbag positioner is located within the steering wheel.

19. The automobile of claim 15 wherein the airbag positioner is located on the shoulder belt.

20. The automobile of claim 15 wherein the airbag positioner is an airbag that is inflated or sized to produce of force to re-position an out-of-position occupant.
